(19) United States
(12) Patent Application Publication
(10) Pub. No.: US 2018/0366034 A1
(43) Pub. Date: Dec. 20, 2018

(54) DEVICE FOR SIMULATING AN ENDOSCOPIC OPERATION VIA NATURAL ORIFICE

(71) Applicants: FUNDACIO INSTITUT DE RECERCA DE L'HOSPITAL DE LA SANTA CREU I SANT PAU, BARCELONA (ES); UNIVERSITAT POLITECNICA DE CATALUNYA, BARCELONA (ES); FUNDACIO INSTITUT DE BIOENGINYERIA DE CATALUNYA (IBEC), BARCELONA (ES)

(72) Inventors: Alicia CASALS GELPÍ, Barcelona (ES); Albert HERNANSANZ PRATS, BARCELONA (ES); Ramon ROVIRA NEGRE, BARCELONA (ES); Joan BASOMBA FELIU, BARCELONA (ES); Roger COMAS PEREZ, BARCELONA (ES)

(73) Assignees: FUNDACIO INSTITUT DE RECERCA DE L'HOSPITAL DE LA S ANTA CREU I SANT PAU, BARCELONA (ES); UNIVERSITAT POLITECNICA DE CATALUNYA, BARCELONA (ES); FUNDACIO INSTITUT DE BIOENGINYERIA DE CATALUNYA (IBEC), BARCELONA (ES)

(21) Appl. No.: 16/061,101

(22) PCT Filed: Dec. 12, 2016
(86) PCT No.: PCT/EP2016/080572

§ 371 Date: Jun. 11, 2018

(30) Foreign Application Priority Data
Dec. 11, 2015 (ES) P201531796

(51) Int. Cl. G09B 23/28

(52) U.S. Cl. CPC G09B 23/285

(57) ABSTRACT

A device for simulating an endoscopic operation via natural orifice, including a physical model of a biological organ including main and inlet modules detachable from each other. The main module may define a main body of the organ with a cavity and the inlet module may define an inlet opening to the cavity of the main module corresponding to the inlet of the biological organ. The cavity of the main module is accessible through the inlet module by an endoscopic tool to actuate in the cavity of the main module. The main module may be configured in such a way that, in use, one or more simulation modules are attachable with the main module to simulate one or more events representative of the actuation of the endoscopic tool in the cavity of the main module.

The present subject matter relates to a device for simulating an endoscopic operation via natural orifice.

### BACKGROUND

Endoscopy may be defined as a diagnostic and/or surgical technique, of minimally invasive surgery branch, which involves the introduction of a camera or lens arranged in a tube or endoscope through a natural orifice or a surgical incision (normally performed in the abdominal wall) for viewing a hollow organ or body cavity. The endoscope may further include one or more surgical elements (e.g. tweezers) which allow surgical interventions in the accessed organ or accessed body cavity.

There exist obvious differences between endoscopic techniques via natural orifice and endoscopic techniques via surgical incision, such as, for example, the type of tools, access paths and surgical fields that are accessed. Therefore, these different techniques may generate different scenarios and therefore require overcoming different difficulties. Laparoscopy is an example of endoscopy via surgical incision, which is typically performed in the abdominal wall. Hysteroscopy and cystoscopy are examples of endoscopy via natural orifice. In the case of hysteroscopy the access is performed vaginally, while in cystoscopy the access is performed via urinary tract.

Devices that allow physical simulation of laparoscopic operations are known. Taking into account the differences between endoscopic techniques via natural orifice and laparoscopic techniques, these prior devices for laparoscopic simulation are not valid for the simulation of endoscopies via natural orifice. The type and number of tools may be different for every type of endoscopy, as well as the access paths and the surgical field.

### SUMMARY

Therefore, there is a need for new devices for simulating an endoscopic operation via natural orifice which at least partially resolve some of the problems mentioned above.

In a first aspect, a device is provided for simulating an endoscopic operation via natural orifice, including a physical model of a biological organ. The physical model of the biological organ may include a main module (or piece) and an inlet module (or piece) that are detachable (i.e. independent) from each other. The main module defines a main body of the organ with a cavity and the inlet module defines an inlet opening to the cavity of the main module corresponding to the inlet of the biological organ.

The main module and inlet module may be attachable to each other through a coupling and decoupling system of easy execution. For example, the coupling system may be a snap system, so that a simple “click” may be sufficient to assemble such modules.

The cavity of the main module is accessible through the inlet module by an endoscopic tool for acting in the cavity of the main module. The main module is configured in such a way that, in use, one or more simulation modules (or pieces) are attachable with the main module for simulating one or more events representative of the actuation by the endoscopic tool in the cavity of the main module.

In some examples, the endoscopic simulation device may further include the endoscopic tool and the simulation module or modules. The endoscopic tool may be configured to access the cavity of the main module through the inlet module and to actuate in the cavity of the main module. The simulation modules may be attachable with the main module and may be configured to simulate one or more events representative of the actuation of the endoscopic tool in the cavity of the main module.

The main module may include one or more simulation modules integrated therein, so that electronics associated with such simulation modules may be, insofar as possible, common or shared electronics. In the case of attachable (or removable) simulation modules, electronics associated with such modules may not be shared, but every module may individually incorporate the necessary electronics for its proper operation.

One aspect of the device is that it may allow the simulation of endoscopic operations via natural orifice with versatility and realism. In particular, with this device, a large variety of biological organs with different morphologies and/or pathologies may be simulated in a relatively simple way. The replacement of the main module or the inlet module of the physical model of the biological organ by another different main or inlet module may allow the simulation of a different biological organ or with different morphologies and/or pathologies. The presence of more or less simulation modules (coupled or integrated with the main module) and/or with different shapes may allow the simulation of organs with diverse pathologies.

A main module, an inlet module and one or more simulation modules may be generated according to a specific morphology of an organ of a particular patient. This morphology, which may also include a specific pathology, may be determined from medical images obtained for this purpose. The main, inlet and simulation modules may be produced (or manufactured) through, for example, a 3D (three-dimensional) printing according to such medical images.

In a case of example, a series of medical imaging tests, such as x-rays, ultrasounds, Computed Tomography, etc. performed on a patient may anticipate some difficulty of a hypothetical endoscopic operation (via natural orifice) to be performed on the patient. Under these circumstances, a proper combination of certain main, inlet and simulation modules of the device may allow a simulation of an organ and pathology very close to reality, according to the performed imaging tests. With this, the endoscopic operation may be simulated as many times as deemed necessary in order to ensure, as far as possible, the overcoming of the anticipated difficulties.

The disclosed device may permit transitioning from one scenario to another in a relatively quick and easy way. A simple substitution of one or more of the (main, inlet and simulation) modules of the device may allow the simulation of an organ and/or pathology completely different from the previous organ and/or pathology. For example, a simulation module with a specific size and shape and placed in a particular position of the main module (of the physical model of the biological organ) may simulate a pathology completely different from the previous one and very close to reality.

In some examples, the main module of the physical model of the biological organ may include at least one coupling opening configured in such a way that one of the simulation modules is attachable to said coupling opening. The main module may have as many coupling openings as deemed necessary to simulate a wide range of, for example, tumor pathologies. The coupling openings may be located so as to simulate the vast majority of known pathologies (according to, for example, historical data) by coupling simulation modules with suitable shape and size.

The coupling of the simulation module to the coupling opening may be, for example, a snap coupling. This feature may allow a quick and easy transition between different “pathological” scenarios with a simple “click” of a simulation module in a coupling opening selected according to the pathology to be simulated.

In some configurations, the device may further include a physical model of an access path to the physical model of the biological organ from the outside. Such a physical model of the access path may be detachable with respect to the physical model of the biological organ. The access path may be, for example, a penis or vagina and its associated urinary tract, an anus and its associated rectum, etc. Thus, a very suitable scenario may be simulated for simulating an endoscopic operation (via natural orifice) under very specific conditions and, therefore, very close to reality. When the physical model of the access path models a vagina, the physical model of the associated biological organ may correspond to a uterus accessible through said vagina, for example.

The physical model of the biological organ and the physical model of the inlet path may be attachable to each other through a coupling and decoupling system of easy execution. For example, said coupling system may be a snap system, so that a simple “click” may be sufficient to assemble such physical models.

In implementations of the device, one of the simulation modules may include a physical model of a tumor or polyp (or set of them) configured in such a way that, in use, it is removable by the endoscopic tool. This simulation module may also include a sensor configured to detect the removal of the tumor or polyp through the endoscopic tool. Therefore, it is possible to simulate a complete endoscopic operation (via natural orifice) including diagnosis and removal of a tumor or polyp, along with the generation of data about the extraction from signals generated by the sensor associated with the simulated tumor or polyp. These data/signals may allow, for example, determining whether the endoscopic tool has been correctly or incorrectly operated by an operator (user, student, surgeon, etc.) to remove the tumor or polyp, among others.

In some examples, one of the simulation modules may include a physical model of a biological organ tissue configured in such a way that, in use, it is removable by the endoscopic tool. This simulation module may also include a sensor configured to detect the removal (and previous resection) of the biological organ tissue through the endoscopic tool. With these features, it is possible to simulate a complete endoscopic operation including diagnosis and extraction of a biological tissue, together with the possibility of generating data about the extraction (and previous resection) obtained from signals generated by the sensor associated with the simulated tissue. This data may allow the determination of whether the endoscopic tool has been correctly or incorrectly operated by an operator (or user, student, surgeon, etc.).

In configurations of the device, at least part of an inner surface of the cavity of the main module of the physical model of the biological organ may be coated with a sensing layer (or sensor-equipped mesh). This sensing layer may be configured to detect a pressure exerted by the endoscopic tool. The presence of the sensing layer may allow performing simulations with a greater degree of realism. It may also offer the possibility to evaluate more rigorously whether the endoscopic tool has been used correctly or incorrectly by a user (or operator, student, surgeon, etc.).

If, for example, the sensor detects that the endoscopic tool comes into contact with a surface of the simulated organ which does not have to be touched, data indicative of bad operation of the endoscopic tool may be generated. The sensor may also detect the intensity of the contact so as to generate data representative of the magnitude of the bad operation (or, in general, of the quality of use) of the endoscopic tool.

In some implementations, at least part of an inner surface of the cavity of the main module of the physical model of the biological organ may be coated with a layer of soft material. This soft material may simulate one or more properties of a biological organ tissue, so that more realistic simulation scenarios may be provided.

In some examples, the inlet module of the physical model of the biological organ may be configured in such a way that, in use, it provides a pivot point for the endoscopic tool. The inlet module may, therefore, have a suitable size and morphology to provide a pivot point very close to reality according to, for example, imaging tests previously performed on the patient. As many endoscopic operations as deemed necessary may be simulated in order to ensure good chance of success of the real endoscopy.

In implementations of the provided device, the inlet module of the physical model of the biological organ may include a sensor for detecting the passage and/or the presence of the endoscopic tool through the inlet opening of the inlet module. This sensor may generate signals indicative of whether the passage of the endoscopic tool through the inlet of the organ is correct or incorrect. The sensor may detect the intensity of the contact between the endoscope and the inlet to the organ in order to estimate to what extent the passage of the endoscope is incorrect. The signals generated by the sensor may be used to produce data representative of the quality of use of the endoscopic tool by an operator (or user, student, surgeon, etc.) during the endoscopic simulation.

In some configurations, the device may include one or more sensors coupled to the endoscopic tool configured to detect the position and/or orientation of the endoscopic tool. The position and/or orientation may be continuously detected and evaluated to determine the quality of use of the endoscopic tool by a user (or operator, student, surgeon, etc.). For this purpose, predefined position/orientation margins depending on the scenario and the type of simulated endoscopy may be taken into account.

If the position and/or orientation of the endoscope evolve substantially within the predefined margins, an output indicative of proper operation of the endoscope may be generated. If, however, the position and/or orientation exceed the predefined margins for at least part of the simulation, the operation of the endoscope may be considered incorrect. In short, a magnitude of the quality of use (correct or incorrect) of the endoscope or endoscopic tool may be derived, depending on the time of execution, economy of motion, proximity to critical regions, etc. Parameters such as the economy of motion and the proximity to critical regions may be determined depending on, for example, whether the position and/or orientation are outside (or inside) margins and to what extent during the simulation.

In some examples, the device may include one or more video recording devices configured for recording different aspects of the endoscopic operation. For example, these devices may perform the function of recording a user of the endoscopic tool, and/or the endoscopic tool itself, and/or an inside of the physical model of the biological organ, etc. during the simulation of the endoscopic operation (via natural orifice).

The recording of the user (or operator, student, surgeon, etc.) during the simulation of the endoscopic operation may be reviewed a posteriori by, for example, the user and/or a mentor (or professor). This review may have the aim of performing, for example, an analysis of the ergonomics and position of the user in order to correct and improve the ergonomics of the trunk and upper limbs of the user.

The recording of the endoscopic tool may be useful for, for example, determining the position and/or orientation of the tool in order to implement the functions described in this respect in other parts of the description. The recording of the inside of the physical model of the biological organ may be useful to analyze certain details of the simulated endoscopic operation which may only be captured inside the organ, in positions close to the simulated pathology.

In some configurations, the device may include a haptic system coupled to the endoscopic tool for transmitting haptic information to a user of the endoscopic tool during the simulation of the endoscopic operation.

The device may generate, during the simulation of the endoscopic operation (via natural orifice) a haptic return that allows informing the student (or user, operator, surgeon, etc.) in real time about the quality of the exercise (or simulation) that is being performed. This haptic return may be performed through signals relating to various sensory channels selected from one or more channels of audio, video, variable frequency strength depending on the quality of execution of the exercise, etc.

The haptic communication may be performed by, for example, producing vibrations to generate information on the state of the execution of the exercise. The vibration, which may be transmitted through the endoscopic tool to the hand of the user, may vary in frequency and intensity according to certain parameters (for example, the distance between the tool and a target point of the simulation).

The device may include, for example, a control unit that may be a computing system connected to at least one of the components (e.g. sensors, cameras, etc.) of the device. The computing system may be configured to execute a computer program for controlling the device, collecting and monitoring input and output signals of the sensors, cameras, etc. This computer program may allow managing all the information relating to operators (or users, students, surgeons, etc.), execution of simulations, evaluation of results, etc. Also, the control unit may be able to manage a network connection for remote storage, for example.

The control unit may also allow maintaining a local or remote database. This database may store required data (e.g. haptic feedback data), and may allow the retrieval and analysis of data on the performed simulations. The recording and analysis of the data may be performed by said computer program executed by the computing system. Statistical data related to the simulations may be generated from the database, for example.

### BRIEF DESCRIPTION OF THE DRAWINGS

Particular implementations of the present subject matter will be described by way of non-limiting examples with reference to the accompanying drawings, in which:

FIG. 1 shows a schematic graphical representation of a physical model of a biological organ and a physical model of an access path suitable for examples of a device for simulating an endoscopic operation.

FIG. 2 shows a schematic graphical representation of an example of a device for simulating an endoscopic operation.

### DETAILED DESCRIPTION

In the following, numerous specific details of the present subject matter will be described in order to provide a thorough understanding thereof. However, a skilled person should understand that the present subject matter may be performed without some or all of these specific details. Moreover, certain well-known elements have not been described in detail in order to not unnecessarily complicate the description of the present subject matter.

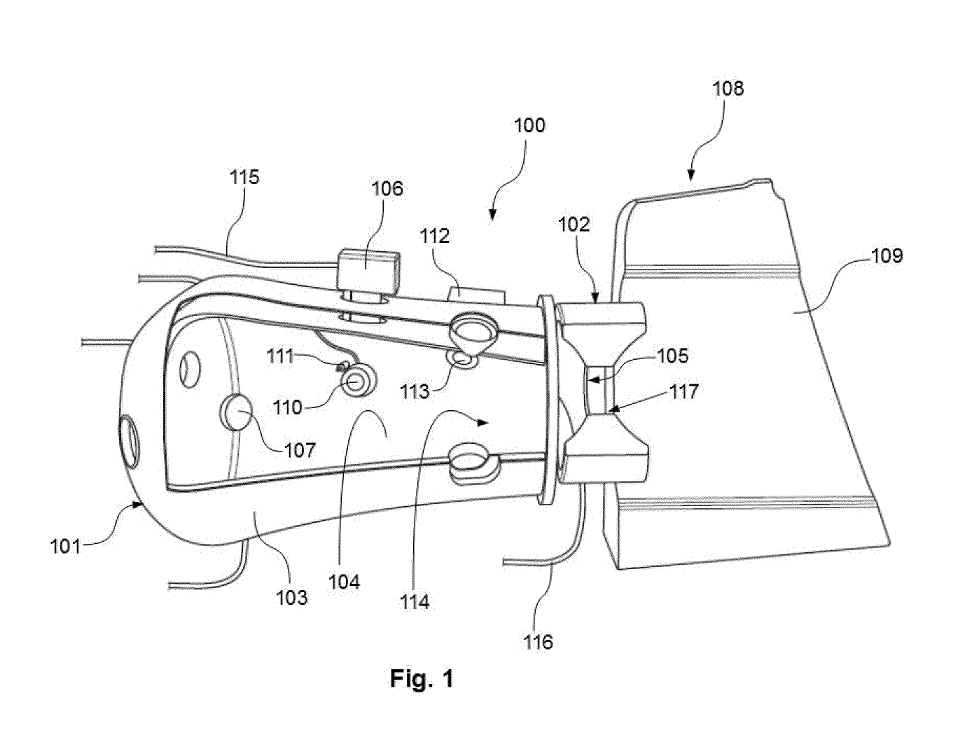

FIG. 1 shows a schematic graphical representation of a physical model of a biological organ 100 and a physical model of an access path 108 suitable for examples of a device for simulating an endoscopic operation (via natural orifice). The physical model of the biological organ 100 may include a main module 101 and an inlet module 102 detachable from each other. The main module 101 may define a main body of the organ 103 with a cavity 104. The inlet module 102 may define an inlet opening 105 to the cavity 104 of the main module 101 corresponding to the inlet of the simulated biological organ.

The main module 101 may include coupling openings 107 that are configured to receive a simulation module 106 through, for example, a snap coupling. One of the coupling openings may be adapted for the coupling of a simulation module 106 including a physical model of a tumor or polyp 110. This simulation module 106 may further include a sensor 111 configured to detect the removal of the tumor (or polyp) 110 by an endoscopic tool (not shown).

One of the coupling openings may be configured for the coupling of a simulation module 112 including a physical model of a biological tissue 113, and a sensor (not shown) to detect the removal (and previous resection) of the tissue 113 through the endoscopic tool.

An inner surface 114 of the cavity 104 of the main module 101 may be coated with a layer of soft material, or with a sensing layer, or with both types of layers. The layer of soft material may simulate some property of a biological organ tissue to provide a more realistic simulation of the biological organ and the endoscopic operation.

The physical model of the access path 108 may be detachable from the physical model of the biological organ 100, and may include an opening 109 representing a natural opening of a human body. For example, the physical model of the biological organ 100 may simulate a rectum intestine, and the physical model of the access path 108 may simulate an anus associated with the rectum intestine.

The opening 105 of the inlet module 102 may be configured in such a way that, in use, it provides a pivot point 117 for the endoscopic tool during the endoscopic operation. The pivot point 117 may have one or more other properties depending on the type of organ represented (or simulated) and the particular patient to whom the simulated organ belongs.

The inlet module 102 and, in general, any of the modules constituting the simulated organ and the simulated access path, may be designed from imaging tests performed on a particular patient. Thus, various endoscopic operation tests may be performed prior to proceeding to the real endoscopy, in order to largely ensure success of the real endoscopic operation.

The inlet module 102 may include one or more sensors (not shown) configured to detect the passage/presence of the endoscopic tool through the opening 105. At least part of these sensors may be pressure sensors configured to detect how the endoscopic tool pivots on the pivot point 117. The sensors of the inlet module 102 may be connected to a control unit (not shown) through suitable cables 116 (or, alternatively, through wireless connection). Thus, the control unit may receive signals from the sensors in order to process them and generate data representative of the quality of execution of at least part of the endoscopic operation (via natural orifice).

The simulation modules 106, 110, 112 and associated sensors 111 may also be connected to the control unit through corresponding cables 115 (or, alternatively, through wireless connection). The sensors 111 may generate and send detection signals to the control unit through said cables 115 (or wireless connection). The control unit may generate data of the performed simulation by processing the received signals. For example, one or more pressure sensors included in the inside 104 of the main module 101 may generate signals relating to the contact between the endoscopic tool and the main module 101. The control unit may receive said signals and generate data indicative of how the endoscopy has been performed from said received signals.

These signals may, for example, indicate the specific surface(s) on which the contact occurs, quantify the intensity of the contact, etc. From these signals, the control unit may generate data on, for example, whether the endoscopic tool has passed correctly through the inlet 105 or, on the contrary, has been inserted incorrectly. The signals representative of the intensity of the contact may allow the control unit to generate data on, for example, possible damages caused by an incorrect insertion of the endoscopic tool.

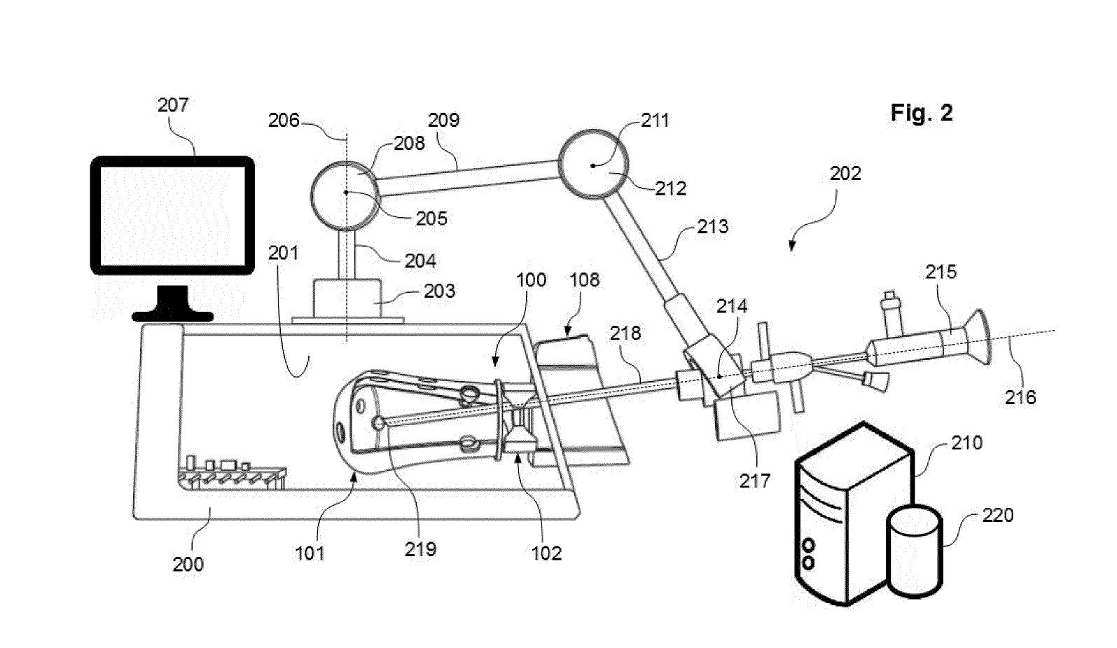

FIG. 2 shows a schematic graphical representation of an example of a device for simulating an endoscopic operation (via natural orifice). The endoscopic simulation device may include a physical model of a biological organ 100 having a main module 101 and an inlet module 102, and a physical model of an access path 108. These physical models of the biological organ 100 and the access path 108 may be equal or similar to those of FIG. 1, for example.

The endoscopic simulation device may also include a casing 200 configured to house in its inside 201 at least the physical model of the biological organ 100, and simulation modules (not shown) equal or similar to those described in relation to FIG. 1.

The endoscopic simulation device may further include an endoscopic tool 202 which may have an articulated arm, a handle 215 and an endoscopic tube 218 for accessing the inside of the main module 101 of the physical model of the biological organ 100.

The articulated arm may include a support base 203 on the protective casing 200, and a first bar 204, second bar 209 and third bar 213 articulated to each other. The first bar 204 may be disposed vertically and may be rotatable around a vertical rotation axis 206. The vertical rotation axis 206 may be a longitudinal axis of the first bar 204.

The first and second bars 204, 209 may be connected through a first ball and socket joint 208. This first ball and socket joint 208 may be configured in such a way that the second bar 209 is movable with respect to the first bar 204 in a rotatory manner around a first horizontal rotation axis 205.

The second and third bars 209, 213 may be connected through a second ball and socket joint 212. This second ball and socket joint 212 may be configured in such a way that the third bar 213 is movable with respect to the second bar 209 in a rotatory manner around a second horizontal rotation axis 211.

The third bar 213 and the endoscopic tube 218 may be connected through a third ball and socket joint 217 configured in such a way that the endoscopic tube 218 is movable with respect to the third bar 213. This movement of the endoscopic tube 218 may be a rotary movement around a third horizontal rotation axis 214.

The rotatory connections between the base 203 and the first bar 204, between the first bar 204 and the second bar 209, between the second bar 209 and the third bar 213, and between the endoscopic tube 218 and the third bar 213 may include a rotation sensor. These rotation sensors may generate signals from which the position and orientation of the endoscopic tool and, in particular, the endoscopic tube 218 may be monitored in a very accurate manner.

The endoscopic tube 218 may include a tip 219 of the tube, a camera for viewing the explored region of the physical model of the biological organ 100. The tip 219 of the endoscopic tube 218 may further include one or more surgical elements to perform surgical actuations in the explored region. Surgical elements of example may be tweezers, a scalpel, etc. remotely controlled by an operator (student, surgeon, etc.) of the endoscopic tool.

The endoscopic tube 218 may be rotatable around a longitudinal axis 216 of the tube 218, so that images of the explored region may be obtained, with the camera of the tip 219 of the tube 218, from different angles or perspectives.

The configuration described for the articulated arm, with diverse degrees of freedom, is just one example of how said arm could be articulated. The endoscopic tool 202 could therefore include other types of articulated arms with more or less degrees of freedom compared to those described in reference to FIG. 2.

The endoscopic simulation device may further include a computing system 210 along with a data storage device 220 for storing data required for proper operation of the endoscopic simulation system. For example, the storage device 220 may include a database containing data of haptic responses, guiding in endoscopic simulations, theoretical training, and many other types of data.

The computing system 210 may be configured to execute one or more computer programs responsible for managing or controlling various functionalities associated with the endoscopic simulation device. These computer programs may be stored in the storage device 220 and may be loaded into a volatile memory (e.g. RAM) each time its execution is required. The management or control of the device may include, for example, collecting data from sensors and/or cameras, processing said data to generate data representative of the performed simulations, storage of images, sounds, etc. generated during endoscopic simulations, etc.

The endoscopic simulation device may further include a monitor or display 207 to display various types of images. These images may be images obtained by cameras located in the cavity 100 of the simulated organ, cameras arranged to record the performance of the user (operator, student, surgeon, etc.), etc. Besides the images about the endoscopic simulation in progress, images of an ideal execution of the endoscopy may also be displayed for guiding the user (operator, student, surgeon, etc.). These images of the ideal endoscopy may be displayed superimposed on the images of the endoscopy in progress for comparative purposes, for example.

The display 207 may be touch-type, as part of a user interface configured to make possible an appropriate communication and interaction between the student (or user, operator, etc.) and the endoscopic simulation device. Said user interface may include, for example, data input modules and output modules or modules for generating information.

The data input modules may include said touch screen and, if desired, a keyboard, a trackball or the like, and pedals for allowing access to or activation of certain functions, such as e.g. moving from one screen to another in a menu, accepting an option, etc. The inclusion of pedals as an or part of an input module allows making the student familiar with the use of the pedals used in the operating room in a real situation.

The output modules may also include said touch screen and, if desired, speakers (not shown). The speakers may allow the user interface to emit audio to provide the students with an aid during the execution of the exercises, and also to emulate the real conditions of an operating room playing recorded sounds during a real situation, etc. The output modules may also include the system of haptic responses described in other parts of this description.

The endoscopic simulation device may allow performing exercises in tutorial mode, for example. The tutorial mode may provide the student with a series of aids so that the student may perform the exercises correctly. These aids may be provided during execution (or endoscopy simulation) time, even though instructions may also be provided prior to the execution of the simulated endoscopy.

As discussed in other parts of this description, different sensory channels may be used to transmit this aid information. For example, this support information may be transmitted through auditory channels, visual channels, and even force feedback channels. The tutorial mode may be applied as first stage in a training course, for example, in order to reduce the need for a “human” mentor.

Any of the examples described in the present disclosure may present, therefore, a high level of modularity and versatility. In particular, different modules used to simulate the (biological) part of the human body may be attachable to each other through a coupling system of easy execution. For example, the coupling system may be a snap system, so that a simple “click” may be sufficient to assemble the desired modules. These modules may be, therefore, easily interchangeable in order to simulate different organs with different morphologies, volumes, pathologies, etc. for performing different simulation exercises with large doses of realism.

The coupling between (main, inlet, simulation, etc.) modules may further include a universal connector to ensure the electrical connectivity between modules. This connectivity may allow that electrical power (from a power supply) may reach any electronic element (e.g. sensors) arranged in any module. The electrical connectivity may also permit proper transmission of data signals between electronic elements (e.g. sensors) arranged in any of the modules and a control unit (computing system, PC, etc.).

According to the aforementioned modular approach, in some endoscopic simulation devices for example, the control unit may be part of a base station. The base station may further include a display, speakers, a power supply, a casing, etc. The casing may be configured to house the modules modelling or simulating the (biological) part of the human body, such as for example: main module and inlet module of a physical model of a biological organ, physical model of an inlet path, etc.

The electronic elements that may be arranged in the modules modelling the (biological) part of the human body may include LEDs, extraction sensors, sensor-equipped meshes, etc. At least part of these electronic elements may be included in simulation modules that are easily attachable with the modules modelling the (biological) part of the human body. According to the purpose of providing a high level of modularity and versatility, said coupling may be, for example, a snap coupling (i.e. by “clicking”).

In the case of simulation modules integrated in the main module, said modules may share at least some of the corresponding electronic elements. For example, said shared (or common) electronics may include a microprocessor configured to interact with the central control unit. This microprocessor may, for example, provide an identifier of the physical model of the biological organ so that the control unit may select control software that is compatible with such physical model in particular. Said selection of software may also be performed depending on an exercise of endoscopic operation selected by the user, for example.

Although only a number of particular implementations and examples of the subject matter hereof have been disclosed herein, it will be understood by those skilled in the art that other alternative implementations and/or uses hereof and obvious modifications and equivalents thereof are possible. Furthermore, the present subject matter covers all possible combinations of the particular implementations that have been described. The numerical signs relating to the drawings and placed between parentheses in a claim are only aimed at increasing the understanding of the claim and shall not be interpreted as limiting the scope of protection of the claim. The scope of the present subject matter should not be limited by particular implementations, but should be determined only by a fair reading of the claims that follow.

Further, although the implementations of the subject matter described with reference to the drawings include computing systems and methods performed by computing systems, the subject matter also extends to computer programs, particularly to computer programs on or in a carrier, adapted for putting the subject matter into practice. The program may be in the form of source code, object code, or an intermediate code between source code and object code, such as in partially compiled form, or in any other form suitable for use in the implementation of the processes according to the subject matter hereof. The carrier may be any entity or device capable of carrying the program.

For example, the carrier may include a storage medium, such as a ROM, for example a CD ROM or a semiconductor ROM, or a magnetic recording medium, for example a floppy disc or hard disk. Further, the carrier may be a transmissible carrier such as an electrical or optical signal, which may be conveyed via electrical or optical cable or by radio or other devices and/or methods.

When the program is embodied in a signal that may be conveyed directly by a cable or other device or devices and/or methods, the carrier may be constituted by such cable or other device or devices and/or methods.

Alternatively, the carrier may be an integrated circuit in which the program is embedded, the integrated circuit being adapted for performing, or for use in the performance of, the relevant processes.

Furthermore, the subject matter hereof may also be implemented by computing systems such as personal computers, servers, a network of computers, laptops, tablets or any other programmable device or computer processor. Further or alternatively, programmable electronic devices may also be used, such as programmable logic controllers (ASICs, FPGAs, PLCs, etc.).

Therefore, the subject matter may be implemented both in hardware and in software or in firmware, or any combination thereof.

1. A device for simulating an endoscopic operation via natural orifice, comprising:
a physical model of a biological organ comprising a main module and an inlet module detachable from each other, the main module defining a main body of the organ with a cavity and the inlet module defining an inlet opening to the cavity of the main module corresponding to the inlet of the biological organ;
the cavity of the main module being accessible through the inlet module by an endoscopic tool to actuate in the cavity of the main module; and
the main module being configured so that, in use, one or more simulation modules are attachable with the main module to simulate one or more events representative of the actuation of the endoscopic tool in the cavity of the main module.

2. A device according to claim 1, further comprising
the endoscopic tool configured to access the cavity of the main module through the inlet module and to actuate in the cavity of the main module; and
the one or more simulation modules attachable with the main module and configured to simulate one or more events representative of the actuation of the endoscopic tool in the cavity of the main module.

3. A device according to claim 1, the main module of the physical model of the biological organ comprising at least one coupling opening configured so that one of the simulation modules is attachable with said coupling opening.

4. A device according to claim 3, wherein the coupling of the simulation module with the coupling opening is a snap coupling.

5. A device according to claim 1, further comprising a physical model of an access path to the physical model of the biological organ from the outside, said physical model of the access path being detachable with respect to the physical model of the biological organ.

6. A device according to claim 1, one of the simulation modules comprising a physical model of a tumor configured so that, in use, the physical model of the tumor is removable by the endoscopic tool, and also comprises a sensor configured to detect removal of the tumor by the endoscopic tool.

7. A device according to claim 1, one of the simulation modules comprising a physical model of a biological organ tissue configured so that, in use, the physical model of the biological tissue is removable by the endoscopic tool, and also comprises a sensor configured to detect removal of the biological tissue by the endoscopic tool.

8. A device according to claim 1, at least part of an inner surface of the cavity of the main module of the physical model of the biological organ being coated with a sensing layer configured to detect a pressure exerted by the endoscopic tool.

9. A device according to claim 1, at least part of an inner surface of the cavity of the main module of the physical model of the biological organ being coated with a layer of soft material simulating one or more properties of a biological organ tissue.

10. A device according to claim 1, the inlet module of the physical model of the biological organ being configured so that, in use, the inlet module provides a pivot point for the endoscopic tool.

11. A device according to claim 1, the inlet module of the physical model of the biological organ comprising a sensor for detecting the passage and/or the presence of the endoscopic tool through the inlet opening of the inlet module.

12. A device according to claim 1 comprising one or more sensors coupled to the endoscopic tool configured to detect the position and/or orientation of the endoscopic tool.

13. A device according to claim 1, comprising one or more video recording devices configured to record a user of the endoscopic tool during the simulation of the endoscopic operation.

14. A device according to claim 1, comprising one or more video recording devices configured to record the endoscopic tool during the simulation of the endoscopic operation.

15. A device according to claim 1, comprising one or more video recording devices configured to record an inside of the physical model of the biological organ during the simulation of the endoscopic operation.

16. A device according to claim 1, comprising a haptic system coupled to the endoscopic tool for transmitting haptic information to a user of the endoscopic tool during the simulation of the endoscopic operation.

17. A device according to claim 2, the inlet module of the physical model of the biological organ being configured so that, in use, the inlet module provides a pivot point for the endoscopic tool.

18. A device according to claim 10, the inlet module of the physical model of the biological organ comprising a sensor for detecting one or both of the passage or the presence of the endoscopic tool through the inlet opening of the inlet module.

19. A device according to claim 17, the inlet module of the physical model of the biological organ comprising a sensor for detecting one or both of the passage or the presence of the endoscopic tool through the inlet opening of the inlet module.

20. A device for simulating an endoscopic operation via natural orifice, comprising
a physical model of a biological organ comprising a main module and an inlet module detachable from each other, the main module defining a main body of the organ with a cavity and the inlet module defining an inlet opening to the cavity of the main module corresponding to the inlet of the biological organ;
the inlet module being replaceable by another different inlet module so as to simulate another different biological organ;
the cavity of the main module being accessible through the inlet module by an endoscopic tool to actuate in the cavity of the main module; and
the main module being configured so that, in use, one or more simulation modules are attachable with the main module to simulate one or more events representative of the actuation of the endoscopic tool in the cavity of the main module.
